(19) United States
(12) Patent Application Publication
(10) Pub. No.: US 2019/0331421 A1
(43) Pub. Date: Oct. 31, 2019

(54) SYSTEM, DEVICE AND PROCESS FOR COOLING DENTAL RESTORATION PARTS

(71) Applicant: Ivoclar Vivadent AG, Schaan (LI)

(72) Inventors: Theresa Senti, Schaanwald (LI); Katja Ott, Eschen (LI); Rudolf Jussel, Feldkirch (AT); Frank Rothbrust, Rons (AT); Lars Arnold, Gams (CH); Stefan Lerch, Bern (CH)

(21) Appl. No.: 16/396,907

(22) Filed: Apr. 29, 2019

(30) Foreign Application Priority Data
Apr. 30, 2018 (EP) 18170105.3

(51) Int. Cl. F27D 9/00; F27B 17/02; F25D 3/00

(52) U.S. Cl. CPC F27D 9/00; A61C 13/083; F25D 3/00; F27B 17/025

(57) ABSTRACT

A system of a dental restoration part or several dental restoration parts, and/or with a dental restoration part which is possibly embedded in a muffle, and a cooling device is provided. The cooling device comprises cooling bodies as bulk material and a movement device by means of which cooling bodies and the dental restoration part(s) may be moved relative to one another.

### CROSS-REFERENCE TO RELATED APPLICATIONS

This application claims priority to European patent application No. 18170105.3 filed on Apr. 30, 2018, the disclosure of which is incorporated herein by reference in its entirety.

### TECHNICAL FIELD

The invention relates to a system of a dental restoration part and a cooling device, as well as an associated process.

### BACKGROUND

Typically, dental restoration parts are produced by heat treatment. Dental furnaces having a firing chamber in which in most cases several dental restoration parts may be fired at the same time serve to heat the dental restoration parts.

In many cases, dental restoration parts consist of specific dental ceramics such as lithium disilicate or zirconium oxide and require a specific firing curve to provide for the desired properties.

Not so long ago, particularly for zirconium oxide, cycle times of several hours, for instance eight hours, were required for this purpose.

Recently, tests have been carried out to significantly reduce the cycle time to significantly shorter cycle times, even in case of zirconium oxide restorations. For this purpose, a larger heating rate and a larger cooling rate have been used. Due to the introduced thermal stress, both is not uncritical.

This holds true particularly for the cooling rate, as thermal stress may lead to brittle failures of the ceramic dental restoration part, or at least to cracks.

Here, micro cracks are particularly critical, as they are overlooked often. In the micro cracks, bacteria may collect in the mouth of the patient which may lead to infections. Substantially, micro cracks in ceramic restorations have a negative effect on the long-term stability and the mechanical properties in the course of the wearing period.

A further problem is break resistance, particularly with complexly constructed dental restorations.

To avoid the known problems a cooling rate is chosen typically which ensures that no cracks and no residual stress, in particular tensile-compressive stress, are caused.

However, as a result the cooling time may possibly be considerably longer than the heating time, which is contrary to the desired short firing cycle.

Frequently, cooling takes place by lifting a firing hood in which the firing chamber is configured. This has the advantage that an avoidable movement does not shake the footprint on which the dental restoration parts rest.

Consequently, the ambient air that enters cools the dental restoration part.

It has already been suggested to effect forced cooling, for instance by means of a fan. However, a serious disadvantage of this solution is that cooling on the side of the fan is carried out considerably faster than on the side facing away from the fan such that heavy thermal stress is induced which may lead to breakage of the dental restoration part.

An improved solution to avoid asymmetric cooling may be taken from DE 195 429 841 C1. In this solution, a firing hood is not only swiveled up but initially lifted vertically and only then swiveled. In this way, uniform admission of air from all sides is made possible, and thus cooling without thermal stress. To avoid thermal stress, initially, the firing hood is only lifted slightly, and subsequently further, such that not too great a delta T occurs.

Still, this solution requires a comparatively long cooling period for this reason.

### SUMMARY

In contrast, the invention is based on the task of providing a system of a dental restoration part or several dental restoration parts and a cooling device as well as an associated process in accordance with the claims, which parts are improved with regard to the cooling efficiency without creating thermal stress.

This task is inventively solved by the features of the main claims. Advantageous developments may be taken from the subclaims.

According to the invention, it is particularly favorable if the dental restoration part(s) is/are in contact with the bed of cooling bodies, and if in this way cooling may be effected by means of a solid-body thermal conduction.

The dental restoration part or the dental restoration parts is/are surrounded by cooling bodies on all sides. This means that unilateral cooling, as is the case when using a fan, is impossible.

Rather, the dental restoration part is cooled uniformly from all sides.

According to the invention, the relative movement between the dental restoration part and the cooling bodies by means of a movement device is also important. It allows leading continuously new and in this respect cooler cooling bodies to the dental restoration part. The heated cooling bodies are led away or mixed in the heap or bed for the dental restoration parts.

The relative movement between the dental restoration part and the cooling bodies may be realized in any desired manner by the movement device. For instance, the dental restoration part may be held in a flow of cooling bodies. In this case, it is favorable if the dental restoration part is also rotated by the flow such that continuously new sides of the dental restoration part come in contact with the flow of cooling bodies.

According to the invention, it is favorable if at least one part of the cooling phase is realized by means of the inventive process comprising the relative movement between cooling bodies and the dental restoration parts.

In this way, very hot dental restoration parts may cool, for instance, in the ambient air for a short time initially. Now, the delta T is very large such that convection cooling is still effective. In this way, for instance, zirconium dioxide may be allowed to cool from approximately 1200° C. or lithium disilicate from approximately 700° C. after the sintering process and opening of the furnace head.

In both cases, solidification of the ceramic material has advanced to such an extent that a movement of the dental restoration part is uncritical.

Subsequently, the dental restoration part is brought into contact with the cooling bodies as bulk material, or the bulk material is fed to the dental restoration part. The inventively effective and uniform contact cooling or thermal conduction cooling is started.

Here, “dental restoration part” refers to any possible types of dental restoration parts in singular or plural: for instance, teeth produced based on standards, or teeth which are adapted to a specific patient. Also inlays, onlays, bridges, crowns, partial crowns, abutments and abutment crowns and dental arches, partial dental arches, partial dentures, full dentures as well as any other dental products which are to be heat-treated.

Furthermore, it refers to muffles into which dental restoration parts are embedded.

Ceramics, composites and metals and metal alloys as well as all other dental materials that require a heat treatment belong to the materials used for dental restoration parts.

Any desired suitable direction of movement may be used for providing the relative movement.

A device having a trickle opening is included herein, for instance. The trickle opening may be above, below or beside the dental restoration part and let pass the cooling bodies as bulk material, namely at a predefined rate of flow.

The rate of flow may be adjustable in addition, for instance by adjusting the size or shape of the trickle opening.

The trickle opening may be provided both upstream and downstream of the dental restoration part.

The dental restoration part may be held on a type of grate or screen that is shaped such that the movement of the cooling bodies leads to a movement of the dental restoration part.

For this purpose, for instance, the main direction of flow of the flow of cooling bodies may be guided slightly to the side of the center of the dental restoration part such that the dental restoration part is rotated along by the friction of the cooling bodies.

The cooling bodies may also be moved in a screen drum just like in a washing drum together with the dental restoration part. Its screen openings may be selected to be so small that the cooling bodies fit through but not the dental restoration part.

Preferably, the cooling bodies are abrasion-resistant and dust-free such that no contaminants stick to the dental restoration part.

Preferably, the cooling bodies have contact surfaces which are shaped differently such that suitable contact surfaces are provided even in case of different dental restoration parts and such that flat contact is possible. In this way, heat dissipation from the restoration to the cooling body is improved.

However, it may also be advantageous if the cooling bodies are substantially ball-shaped. Cooling bodies of improved circularity exhibit the best flow properties, which proves advantageous to the cooling effect particularly because of the intensive movement.

Additionally, cooling bodies of this type prevent protrusions thereof from damaging the dental restoration.

When the contact to the dental restoration parts is rather point-shaped due to the ball-shaped configuration of the contact surfaces, heat is dissipated only in a point-shaped manner. Then, it is important that a plurality of contact points is provided in order to still ensure the desired intensive but gentle cooling effect.

In case of a smaller relative size of the cooling bodies with regard to the dental restoration parts a larger number of contact points is created, and a more intensive cooling effect accordingly.

In this respect, the cooling efficiency may be adapted to the requirements largely by means of a respective dimensioning.

As a precaution, the dental restoration part may still be cleaned, for instance, by means of pressurized air after the inventive cooling.

A deep-freezing device as part of the cooling device is particularly favorable. It may perform subsequent cooling of the cooling bodies, if necessary. For this purpose, a changing part of the cooling bodies ends up near the deep-freezing device during its relative movement with regard to the dental restoration part or the muffle and is cooled subsequently.

This is particularly favorable for the last phase of cooling close to room temperature as it may then be accelerated significantly. The deep-freezing device may be located externally or preferably at the bottom of the relative movement space of the cooling bodies.

According to the invention, it is favorable if the cooling bodies consist of a material which enables proper dissipation of heat. It is possible, for instance, to use sintered ceramic bodies having purposefully configured contact surfaces as cooling bodies. Alternatively, a metallic realization of the cooling bodies may also be striven for, for instance, particularly if a muffle is to be cooled, wherein metallic cooling bodies allow for improved conduction of heat. Material compounds or composite materials made of metal and ceramic are also favorable as then the ceramic outer surface is abrasion-resistant and avoids contamination and metal cores accelerate the dissipation of heat.

Metal balls coated with ceramic are also particularly favorable for the use as cooling bodies.

It is to be understood that the cooling bodies may withstand the maximum temperature of the dental restoration part, for instance 1200° C. or 1000° C.

By means of the establishment of contact, heat is transferred from the dental restoration part to the cooling bodies. In this way, the cooling bodies are slightly heated and the dental restoration part is cooled substantially. The mass of the dental restoration parts is to amount to only a fraction of the total mass of the cooling bodies, for instance, 10 to 100%. The same holds true for the heat capacity.

Still, the temperature of the cooling bodies increases slightly due to the heat supply which exists in this respect. In order to compensate for this, cooler cooling bodies may be supplied towards the end of the cooling cycle, for instance, cooling bodies which were stored in a fridge previously.

In an advantageous configuration, it is provided that each cooling body comprises a plurality of contact surfaces for contact with the dental restoration part which have in particular different sizes and shapes.

In a further advantageous configuration, it is provided that the cooling bodies comprise ball-shaped contact surfaces, straight contact surfaces and/or concave and/or convex contact surfaces, in particular a combination thereof.

The cooling bodies and the dental restoration part are stored in a randomly configured room or area in which they move relative to one another having alternating contacts. In this respect, this room or area is referred to as a relative movement space and may be, for instance, a vessel or a part of a vessel or, for instance, the area or room above a base.

Another possibility is to provide for a waterbed below a grate or screen to receive the dental restoration part. In that case, the cooling bodies fall onto the hot dental restoration part initially and cool it. When a temperature of slightly more than room temperature, for instance 60° C., is reached, the supply of cooling bodies is continued in such a way that the cooling bodies, which are provided as bulk material, slide into the waterbed next to the grate or screen or therethrough. The water level rises such that the water may reach the dental restoration part and continues to cool it.

It is particularly favorable if the cooling bodies comprise a specific weight which corresponds to the weight of the dental restoration part, possibly including its embedding, with a deviation of +/−30% at most, in particular +/−10% at most.

A movement of the cooling bodies relative to the dental restoration part supported by gravitation is preferred. In an advantageous configuration, it is provided that first larger and then smaller cooling bodies are brought into contact with the dental restoration part. The cooling speed directly depends on the number of contact points which in turn depends on the size of the cooling bodies approximately with 1/diameter² such that in this way towards the end of the cooling cycle the cooling speed may be increased again with respect to the decreasing delta T.

If this is not possible, it is alternatively possible to use a stirrer, for instance a magnetic stirrer. Typically, it comprises a stirring bar which moves both the cooling bodies and the dental restoration parts and ensures the desired alternating establishment of contact.

In another embodiment, it is provided that the dental restoration part may be placed on the cooling bodies when the stirrer is turned off, without sinking in, and that it is moved together with the cooling bodies in a way sunk into them when the stirrer is turned on.

Advantageously, the stirrer may be a magnetic stirrer whose stirring bar is enclosed by a temperature-resistant, smooth and non-abrasive material, is free from edges and comprises roundings. Its radius amounts to at least 3 mm, in particular at least 5 mm. In this embodiment, the stirrer may be provided with an abrasion-resistant and heat-resistant coating, for instance enameled, and may be free from edges in addition.

In this embodiment, it may be provided that the stirrer is an electrically driven stirrer which may be turned on automatically particularly upon placement of a dental restoration part.

### BRIEF DESCRIPTION OF THE DRAWINGS

Further advantages, details and features may be taken from the following description of several exemplary embodiments of the invention in conjunction with the drawings.

FIG. 1 shows a schematic side view of an embodiment of the invention;

FIG. 2 shows a further embodiment of the invention, also in a schematic illustration; and

FIG. 3 shows a third embodiment of the invention which is modified with respect to FIG. 2.

### DETAILED DESCRIPTION

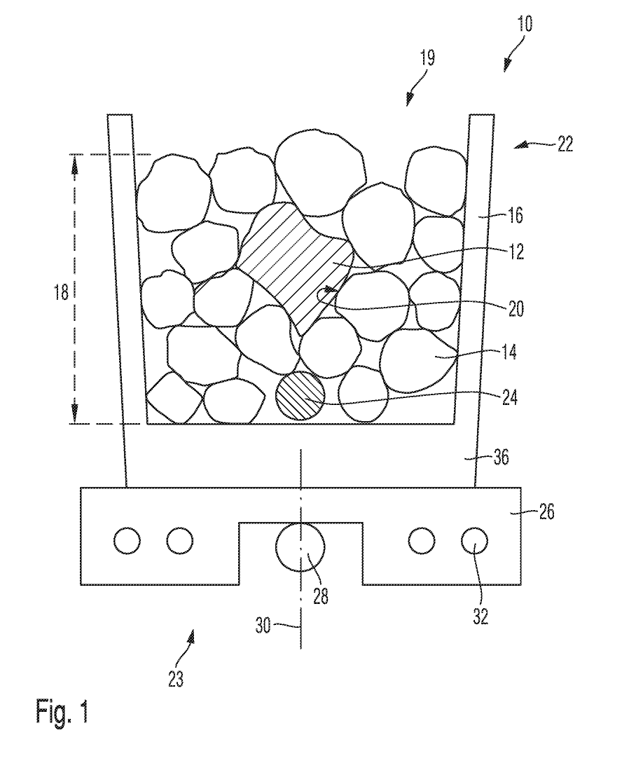

FIG. 1 shows an inventive system 10 of a dental restoration part 12 and a cooling device 19. The dental restoration part 12 is received and embedded in a plurality of cooling bodies 14.

The cooling bodies 14 are received in a vessel 16 as bulk material, namely up to a filling level 18. When the dental restoration part 12 is inserted, the filling level 18 is at approximately 90% of the height of the vessel and is considerably lower, for instance at 80%, without the dental restoration part.

The cooling bodies 14 are substantially ball-shaped, but comprise contact surfaces 20 in numerous different designs, that is to say shapes and sizes. They are configured to offer numerous possibilities of being in contact with the dental restoration part 12 in a flat manner. Preferably, different sizes of balls are provided wherein the smallest balls have a size of not less than 0.05 mm. Preferably, the largest balls have a diameter which ensures that they fit even into small cavities of the restoration.

The contact surfaces 20 support the transfer of heat particularly well.

In FIG. 1, the contact surfaces are illustrated in an uneven distribution deliberately. This is intended and allows for different possibilities of contact with the dental restoration part 12. The inventive cooling device 19 also comprises a stirrer 23. It serves to stir the initially hot dental restoration part 12 with the initially cold cooling bodies 14. The mass of the cooling bodies 14 exceeds that of the dental restoration part by a multiple, for instance by 5 to 200 times, by 20 times in the exemplary embodiment illustrated.

The stirring motion causes alternating contact of the surfaces of the dental restoration part 12 with contact surfaces 20 of the cooling bodies 14. In this way, continuously new and in many cases cold contact surfaces 20 come into contact with the dental restoration part 12 which cool it surprisingly fast but still gently.

According to the invention, the cooling bodies preferably comprise a medium value of thermal conductivity, considerably larger than plastic and considerably smaller than metal. They may consist of ceramics, for instance.

It is particularly favorable that the dental restoration part 12 is received completely in the bed 22 of cooling bodies 14. To ensure this, the specific weight of the cooling bodies 14 is at most as large as the specific weight of the dental restoration part 12, and preferably 20% smaller. Thus, the dental restoration part 12 sinks into the bed 22 and is surrounded completely by the cooling bodies 14 thereat.

The inventive stirrer 23 is configured as a magnetic stirrer in the exemplary case. For this purpose, the vessel 16 is non-ferromagnetic, that is so say permeable to magnetic forces. A stirring bar 24 is received at the bottom center of the vessel 16. It is rather elongated in a way known per se and, in the exemplary embodiment illustrated, comprises a circular cross-section and a rounded end.

The stirring bar 24 comprises a coating made of glass, an enameling, or a coating made of PTFE, which is not apparent from FIG. 1.

Further, the stirrer comprises a support plate 26 as well as a magnet 28 which is received in the support plate 26 and rotates around an axis 30.

Due to the magnetic force, the stirring bar 24 also rotates around the axis 30 in a way known per se and thus sets the cooling bodies 14 and the dental restoration part 12 in motion.

By means of this movement, continuously new parts of the dental restoration part 12 come into contact with different contact surfaces 20 of different cooling bodies.

In the exemplary embodiment illustrated, the support plate 26 comprises a cooling coil 32 which cools it further. The cooling bodies 14 are cooled subsequently by the relatively thick bottom 36 of the vessel 16 which rests on the support plate 26.

However, in case of an accordingly large and thus favorable mass ratio between the cooling bodies 14 and the dental restoration part 12 this is not required such that subsequent cooling is expendable.

As an alternative to subsequent cooling, spare cooling bodies 14 may be kept ready in a storage vessel, and after the dental restoration part 12 has cooled the vessel 16 containing the cooling bodies 14 and the dental restoration part 12 is emptied completely without further ado, and a new bed 22 of cooling bodies 14 is provided from the storage vessel in the vessel 16 for receiving the next hot dental restoration part 12.

To operate the inventive cooling device 19 the hot dental restoration part 12 is placed initially on the bed 22 of cooling bodies 14. The stirrer 23 is then put into operation immediately and causes the cooling bodies 14 to move driven by the stirring bar 24.

As a result, the slightly heavier dental restoration part 12 sinks into the bed 22 of cooling bodies 16 and is cooled from all sides.

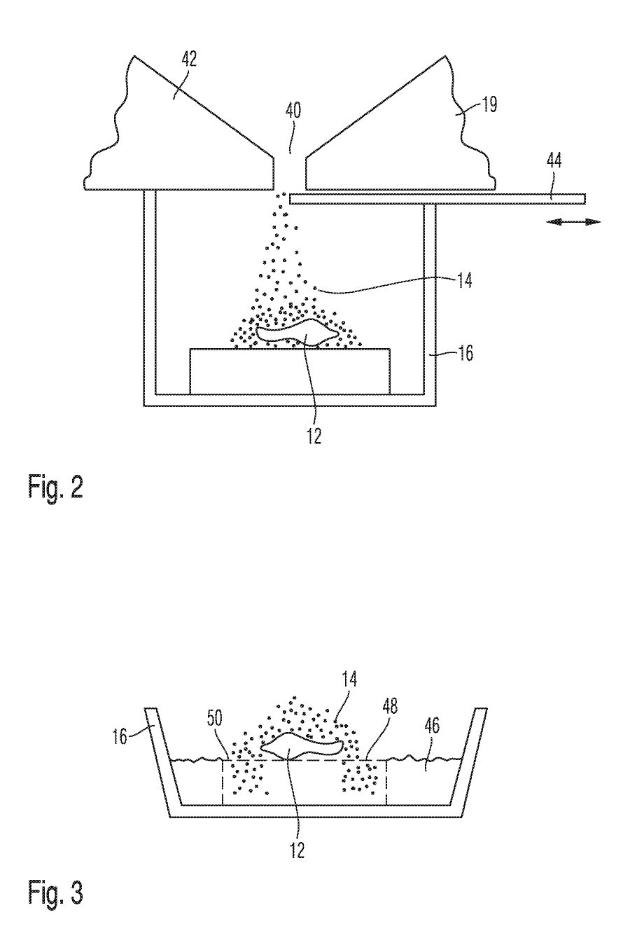

FIG. 2 shows a modified embodiment of an inventive system 10. In this embodiment, the cooling device 19 comprises a trickle opening 40. The trickle opening 40 is disposed at the bottommost position of a bulk material container 42 for cooling bodies 14.

Preferably, the trickle opening 40 may be adjusted with respect to the size of its opening and the cross-section of its opening. This may be realized by means of a slider 44, as is schematically illustrated in FIG. 2.

The bulk material container 42 together with the trickle opening 40 acts as an hourglass. Cooling bodies 14 fall from the trickle opening 40 onto the dental restoration part 12. There, they form a type of heap under which the dental restoration part 12 is buried such that it is cooled through contact with the cooling bodies 14.

In a further modified embodiment, it is provided to dispose a small shaking device below the dental restoration part 12. It causes continuously new cooling bodies 14 to come into contact with the dental restoration part such that the cooling effect is intensified.

A further modified embodiment of an inventive system 10 is apparent from FIG. 3. Here, a water bath 46 extends just below the dental restoration part 12. For this purpose, the dental restoration part 12 rests on a pedestal 48 having a height, which is sufficient that the dental restoration part 12 is above the water level at the beginning of the cooling process. Now, the dental restoration part 12 is cooled, namely initially substantially from the top, by means of cooling bodies 14 which are applied, for instance, through the trickle opening 40 according to FIG. 2.

The cooling bodies 14 fall through the pedestal which is provided with a grate 50 into the water 46. As a result, the water level rises and thus the dental restoration part 12 is also cooled from below, in addition.

Here, an initially gentle cooling by means of the balls is favorable, and then, when thermal shocks are not to be expected anymore, at for instance 60° C., a quick cooling process to end temperature by means of water is carried out. As a result, the delta T is increased again such that final cooling does not proceed too slowly.

Instead of water as mentioned herein any other desired liquid cooling medium may be used which gets along with the respectively used material of the dental restoration part 12.

It is particularly favorable to adapt the thermal conductivity and thermal capacity, but also the mass of the cooling medium, to that of the cooling bodies 14 in order to ensure uniform cooling.

In a further embodiment, a type of washing drum is provided as a vessel.

In case of cooling by free convection, long waiting times are caused between the end of the heat treatment and the point in time at which the restoration may be processed further.

In an inventive embodiment, cooling is provided in the form of a washing drum. A rotating cylinder comprises numerous holes to form a screen. Either, the restoration rests freely among the balls or in a fixed cage which is “permeable” to the balls.

The cooling bodies or the granules must withstand the maximum temperature of the dental restoration part (approx. 1000° C.) and must absorb heat as fast and well as possible.

It is particularly favorable if—regardless of the embodiment—the restoration is in a defined region/at a defined position such that it is not necessary to look for it among the cooling bodies after the cooling process has ended.

1. A system for cooling one or more dental restoration parts, and/or one or more dental restoration parts embedded in a muffle comprising
a cooling device,
one or more dental restoration parts,
wherein the cooling device comprises cooling bodies (14) as bulk material and a movement device by which cooling bodies (14) and the dental restoration part(s) (12) may be moved relative to one another.

2. A system for cooling one or more dental restoration parts, and/or one or more dental restoration parts embedded in a muffle comprising
a cooling device,
one or more dental restoration parts,
wherein the cooling device comprises cooling bodies (14) as bulk material, and
wherein the cooling device (19) comprises a trickle opening (40) for the cooling bodies (14), above and/or below the one or more dental restoration parts (12).

3. The system as claimed in claim 1,
wherein the movement device comprises a movement element which is intended to move the cooling bodies (14) together with the one or more dental restoration parts in a relative movement space of cooling bodies (14) and the one or more dental restoration parts (12).

4. The system as claimed in claim 1,
wherein the cooling bodies (14) are configured as one or more of granules, hollow bodies, prismatic bodies, cuboids with rounded corners and edges, and round bodies.

5. The system as claimed in claim 1,
wherein the cooling bodies (14) are each configured in a shape of a ball, each comprising contact points and/or contact surfaces.

6. The system as claimed in claim 1,
wherein a number of contact points and/or contact surfaces between the one or more dental restoration parts and the cooling bodies is between 3 contacts/cm² and 100,000 contacts/cm² or is between 12 contacts/cm² and 12,000 contacts/cm².

7. The system as claimed in claim 1,
wherein the cooling bodies (14) comprise a ceramic, glass or of metal, a composite of ceramic and/or glass and/or metal.

8. The system as claimed in claim 7,
wherein the ceramic comprises aluminum oxide or zirconium oxide and the composite comprises metal cooling bodies coated with a glass or ceramic.

9. The system as claimed in claim 1,
wherein the cooling bodies (14) for dental restoration parts (12) comprise a size between 50 μm and 10 mm.

10. The system as claimed in claim 1,
wherein a closed or open vessel (16) receives the cooling bodies (14) and the one or more dental restoration parts (12),
wherein volume of the cooling bodies (14) is at least three times volume of the one or more dental restoration parts (12).

11. The system as claimed in claim 10,
wherein the vessel (16) for receiving the cooling bodies and the one or more dental restoration parts, comprises a cooling body support surface which comprises active cooling elements by which the cooling bodies may be cooled subsequently.

12. The system as claimed in claim 1,
wherein a vessel (16) comprises a reception volume for receiving the cooling bodies (14) and the one or more dental restoration parts (12), said reception volume having a volume many times the volume of the dental restoration part.

13. The system as claimed in claim 1, wherein the cooling bodies are required cooling bodies, said system further comprising
cooling bodies that are not required, said cooling bodies that are not required are stored in a vessel at room temperature and are exchangeable with the required cooling bodies.

14. The system as claimed in claim 1,
wherein a deep-freezing device as part of the cooling device is adjacent to or in a vicinity of the cooling bodies during relative movement of the cooling bodies with regard to the one or more dental restoration parts or the muffle for subsequent cooling thereof, and
wherein the deep-freezing device is disposed at the bottom of the relative movement space of the cooling bodies (14).

15. The system as claimed in claim 1,
wherein the at least one part of the cooling bodies (14) is stored in a deep-freezing device, at a temperature which is significantly below room temperature or below 0 degrees, and is intended to be used towards the end of the cooling phase.

16. The system as claimed in claim 1,
wherein a vessel (16) comprises a liquid for receiving the one or more dental restoration parts and the cooling bodies.

17. The system as claimed in claim 16,
wherein the liquid is located below the one or more dental restoration parts before the cooling bodies (14) are placed or inserted, and
wherein a level of liquid rises as the cooling bodies (14) are inserted and whereby the liquid reaches the one or more dental restoration parts (12).

18. The system as claimed in claim 2,
wherein the size and/or dimensions of the trickle opening (40) are adjustable.

19. A process for cooling a dental restoration part (12) with or without being embedded in a muffle, using a cooling device (19), comprising
receiving one or more dental restoration parts (12) in a bed of loose cooling bodies (14) of the cooling device (19),
said cooling bodies (14) being moved as bulk material relative to the one or more dental restoration parts (12),
wherein contact surfaces (20) of the cooling bodies (14) move and contact with the one or more dental restoration parts (12) and cool said one or more dental restoration parts thereat.

20. A process for cooling a dental restoration part (12) with or without being embedded in a muffle comprising
using a cooling device (19),
wherein cooling bodies (14) fall onto the dental restoration part from a bulk material container (42) above the dental restoration part (12) through a trickle opening,
wherein changing contact surfaces (20) of the cooling bodies (14) are in contact with the dental restoration part (12) and cool said dental restoration part thereat.

21. A process for cooling one or more dental restoration parts (12) with or without being embedded in a muffle, comprising
using a cooling device (19),
wherein a plurality of cooling bodies (14) having a size of more than 1 mm, each having changing, contact surfaces (20) in contact or in cold conduction connection with the one or more dental restoration parts and
cool said one or more dental restoration parts thereat.

22. A process for cooling a dental restoration part(s) as claimed in the claim 19,
wherein initially larger and then smaller cooling bodies are brought into contact with the one or more dental restoration parts (12).
